(19) United States
(12) Patent Application Publication
(10) Pub. No.: US 2003/0193258 A1
(43) Pub. Date: Oct. 16, 2003

(54) Composite powder metal rotor sleeve

(76) Inventors: Frederick B. Reiter JR., Cicero, IN (US); Michael Jeffrey Lowry, Indianapolis, IN (US); Tom L. Stuart, Pendleton, IN (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 10/123,505

(22) Filed: Apr. 16, 2002

(51) Int. Cl. H02K 1/00

(52) U.S. Cl. 310/216

(57) ABSTRACT

A composite powder metal rotor sleeve for slipping over a conventional rotor core to form a rotor assembly in an electric machine. The sleeve includes alternating magnetically conducting segments of sintered ferromagnetic powder metal and magnetically non-conducting segments of sintered non-ferromagnetic powder metal. A rotor assembly is also provided in which a rotor core of stamped laminations is attached to a shaft, and the composite sleeve of the present invention circumferentially surrounds the rotor core. There is further provided alternative methods of making an annular composite powder metal rotor sleeve of the present invention, including a compaction-sintering method, and injection molding method, and a sinterbonding method.

### FIELD OF THE INVENTION

This invention relates generally to electric machines, and more particularly, to the manufacture of rotor sleeves for use with rotor cores in electric machines.

### BACKGROUND OF THE INVENTION

It is to be understood that the present invention is equally applicable in the context of generators as well as motors. However, to simplify the description that follows, reference to a motor should also be understood to include generators.

In the field of electric machine rotors and generators, the cores of the machines are typically constructed of thin laminated structures, for example, thin die stamped metal sheets, laser cut thin sheets or electric discharge machined thin sheets, that are stacked on the rotor shaft and secured together. These laminations are configured to provide a machine having magnetic, non-magnetic, electric, plastic and/or permanent magnet regions to provide the flux paths and magnetic barriers necessary for operation of the machines. By way of example, synchronous reluctance rotors formed from stacked axial laminations are structurally weak due to problems associated both with the fastening together of the laminations and with shifting of the laminations during operation of their many circumferentially discontinuous components. This results in a drastically lower top speed. Similarly, stamped radial laminations for synchronous reluctance rotors require structural support material at the ends and in the middle of the magnetic insulation slots. This results in both structural weakness due to the small slot supports and reduced output power due to magnetic flux leakage through the slot supports. There are various other types of machines utilizing rotors comprising stacked axial or stamped radial laminations, including switched reluctance machines, induction machines, salient pole machines, surface-type permanent magnet machines, circumferential-type interior permanent magnet machines, and spoke-type interior permanent magnet machines. Each of these machines utilizes rotor cores of composite magnetic, non-magnetic, electric, plastic and/or permanent magnet laminations that suffer from the aforementioned problems.

Despite the aforementioned problems, and the general acceptance of conventional lamination practices as being cost effective and adequate in performance, new powder metal manufacturing technologies can significantly improve the performance of electric machines by bonding magnetic (permeable) and non-magnetic (non-permeable) materials together. Doing so permits the use of completely non-magnetic structural supports that not only provide the additional strength to allow the rotors to spin faster, for example up to 80% faster, but also virtually eliminate the flux leakage paths that the traditionally manufactured electric machines must include to ensure rotor integrity, but which lead to reduced power output and lower efficiency.

Powder metal manufacturing technologies that allow two or more powder metals to be bonded together to form a rotor core have been disclosed. The following co-pending patent applications are directed to composite powder metal electric machine rotor cores fabricated by a compaction-sinter process: U.S. patent application Ser. No. 09/970,230 filed on Oct. 3, 2001 and entitled “Manufacturing Method and Composite Powder Metal Rotor Assembly for Synchronous Reluctance Machine”; U.S. patent application Ser. No. 09/970,197 filed on Oct. 3, 2001 and entitled “Manufacturing Method And Composite Powder Metal Rotor Assembly For Induction Machine”; U.S. patent application Ser. No. 09/970,223 filed on Oct. 3, 2001 and entitled “Manufacturing Method And Composite Powder Metal Rotor Assembly For Surface Type Permanent Magnet Machine”; U.S. patent application Ser. No. 09/970,105 filed on Oct. 3, 2001 and entitled “Manufacturing Method And Composite Powder Metal Rotor Assembly For Circumferential Type Interior Permanent Magnet Machine”; and U.S. patent application Ser. No. 09/970,106 filed on Oct. 3, 2001 and entitled “Manufacturing Method And Composite Powder Metal Rotor Assembly For Spoke Type Interior Permanent Magnet Machine,” each of which is incorporated by reference herein in its entirety. Additionally, the following co-pending application is directed to composite powder metal electric machine rotor cores fabricated by metal injection molding: U.S. patent application Ser. No. 09/970,226 filed on Oct. 3, 2001 and entitled “Metal Injection Molding Multiple Dissimilar Materials To Form Composite Electric Machine Rotor And Rotor Sense Parts,” incorporated by reference herein in its entirety. Both the compaction-sinter process and the metal injecting molding process (as disclosed in the above-referenced patent applications) lead to the advantages described above, such as strong structural support and non-existent permeable flux leakage paths, and do provide an opportunity to manufacture an electric machine that costs less, spins faster, provides more output power, and is more efficient.

Despite the improvement that can be achieved by switching to powder metal rotor cores, manufacturers still use the stamped and stacked laminations. A need thus exists for the continued use of conventional rotor cores, but with modification to the rotor assembly to achieve improved performance, such as low reluctance, highly efficient flux paths and material strength to allow the rotor to spin at higher speeds.

### SUMMARY OF THE INVENTION

The present invention provides a composite powder metal rotor sleeve for slipping over a conventional rotor core to form a rotor assembly in a permanent magnet machine, salient pole machine, or induction machine. The sleeve includes alternating magnetically conducting segments of sintered ferromagnetic (permeable) powder metal and magnetically non-conducting segments of sintered non-ferromagnetic (non-permeable) powder metal. There is also provided a rotor assembly having a rotor core of stamped laminations attached to a shaft, and the rotor sleeve of the present invention circumferentially surrounding the rotor core to provide a magnetically conducting (permeable) material through the direct flux axis thereby permitting a low reluctance/highly efficient flux path and a non-permeable section to provide material strength to allow for high speed rotation.

There is further provided a method of making such a composite powder metal rotor sleeve in which a die is filled according to the pattern, followed by pressing the powder metal and sintering the compacted powder to achieve a high density composite powder metal rotor sleeve of high structural stability. In another example of a method of the present invention, the powder metal materials are each mixed with a binder system to form feedstocks, the feedstocks are melted and concurrently or sequentially injected into a mold and allowed to solidify, and the solidified composite green compact is then subjected to binder removal and sintering processes to achieve a high density composite powder metal rotor sleeve of high structural stability. In yet another example of a method of the present invention, the individual segments that comprise the rotor sleeve are manufactured separately as green-state components, by either compaction or injection in a mold, then assembled adjacent each other in the desired pattern. A small amount of powder metal is provided at the boundaries between green segments, and the assembly is sinterbonded to achieve a high-density composite powder metal rotor sleeve of high structural stability.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a rotor assembly including a composite powder metal rotor sleeve of the present invention having alternating magnetically conducting segments and magnetically non-conducting segments.

FIG. 2 is a plan view of the rotor assembly of FIG. 1 further including a stator core.

FIGS. 3, 4 and 5 are plan views of alternative embodiments of composite powder metal rotor sleeves of the present invention on different types of rotor cores.

FIG. 6 is a perspective view of an insert for use in a compaction-sintering method of the present invention.

FIG. 7 is a perspective view of an inner bowl and outer bowl of a hopper that may be used for filling the insert of FIG. 6.

FIGS. 8A-8E are cross-sectional schematic views of a method of the present invention using the insert of FIG. 6 and the hopper of FIG. 7 to produce the rotor sleeve of FIGS. 1 and 2.

FIGS. 9-10 are schematic views of embodiments of a molding step in a metal injection molding process in accordance with the present invention.

FIG. 11 is a partially exploded plan view of a partially assembled ring for the rotor assembly of FIG. 1 prior to sinterbonding.

FIG. 11A is an enlarged view of encircled area 11A of FIG. 11.

### DETAILED DESCRIPTION

The present invention provides composite powder metal rotor sleeves for rotor assemblies in electric machines. Electric machines incorporating the composite powder metal rotor sleeves exhibit high power density and efficiency and high speed rotating capability. To this end, a sintered powder metal sleeve is fabricated to comprise alternating magnetically conducting segments and magnetically non-conducting segments. The two powder materials are joined together via a press and sinter operation, an injection molding operation or a sinterbonding operation into an annulus, thus forming a cylindrical shape that fits over the rotor's periphery. The sleeve not only provides a magnetically conducting (permeable) material through the direct flux axis, thereby permitting a low reluctance/highly efficient flux path, it also provides material strength that, when combined with non-permeable material, allows the rotor to spin to much higher speeds than a conventional rotor core without the sleeve.

The magnetically conducting segments comprise a sintered ferromagnetic powder metal, also referred to as a permeable or magnetic material. The ferromagnetic powder material may be a soft ferromagnetic powder metal. In an embodiment of the present invention, the ferromagnetic powder metal is nickel, iron, cobalt or an alloy thereof. In another embodiment of the present invention, this ferromagnetic metal is a low carbon steel or a high purity iron powder with a minor addition of phosphorus, such as covered by MPIF (Metal Powder Industry Federation) Standard 35 F-0000, which contains approximately 0.27% phosphorus. In general, AISI 400 series stainless steels are magnetically conducting, and may be used in the present invention.

The magnetically non-conducting segments comprise a sintered non-ferromagnetic powder metal, also referred to as non-permeable or non-magnetic material. In an embodiment of the present invention, the non-ferromagnetic powder metal is austenitic stainless steel, such as SS316. In general, the AISI 300 series stainless steels are non-magnetic and may be used in the present invention. Also, the AISI 8000 series steels are non-magnetic and may be used.

In an embodiment of the present invention, the ferromagnetic metal of the magnetically conducting segments and the non-ferromagnetic metal of the magnetically non-conducting segments are chosen so as to have similar densities and sintering temperatures, and are approximately of the same strength, such that upon compaction-sintering, injection molding or sinterbonding, the materials behave in a similar fashion. In an embodiment of the present invention, the ferromagnetic powder metal is Fe-0.27%P and the non-ferromagnetic powder metal is SS316.

The powder metal rotor sleeves of the present invention typically exhibit magnetically conducting segments having at least about 95% of theoretical density, and typically between about 95%-98% of theoretical density. Wrought steel or iron has a theoretical density of about 7.85 gms/cm³, and thus, the magnetically conducting segments exhibit a density of around 7.46-7.69 gms/cm³. The non-conducting segments exhibit a density of at least about 85% of theoretical density, which is on the order of about 6.7 gms/cm³. Thus, the non-ferromagnetic powder metals are less compactable then the ferromagnetic powder metals.

The powder metal sleeves can essentially be of any thickness. The rotor sleeve is slid over the conventional rotor core of stamped laminations and aligned with respect to the rotor core such that the magnetic flux paths are aligned along the shaft. Several sleeves may be placed axially along the rotor core to cover the entire length of the rotor core. The non-ferromagnetic powder metal acts as an insulator between the aligned flux paths and increases the structural stability of the assembly. This arrangement allows better direction of magnetic flux and improves the torque of the rotor assembly.

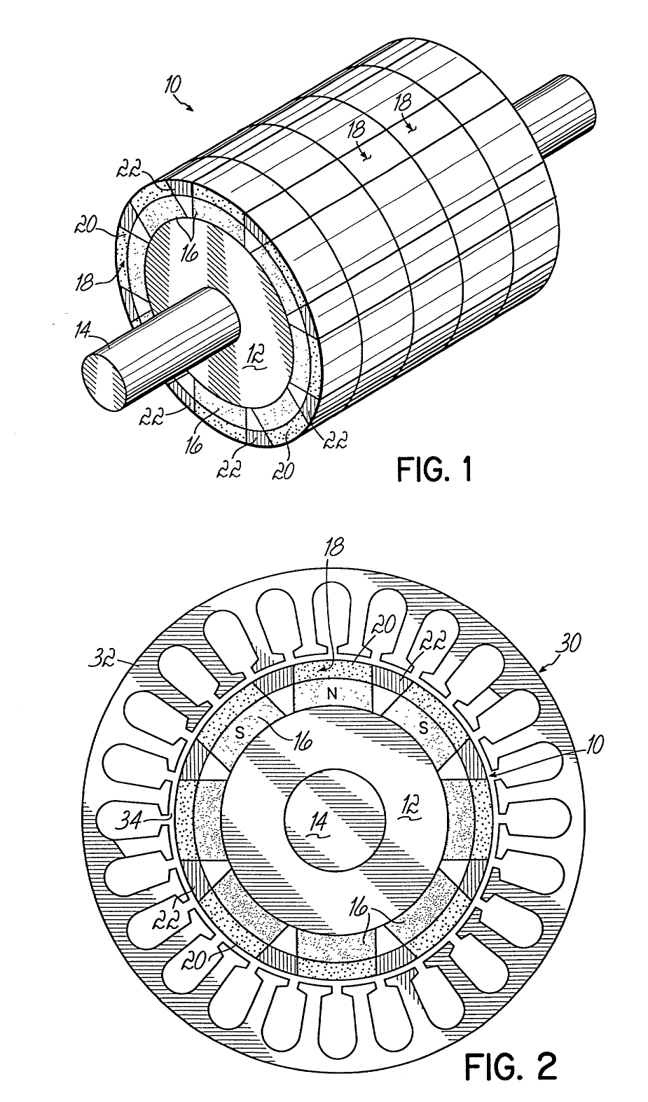

With reference to the Figures in which like numerals are used throughout to represent like parts, FIG. 1 depicts in perspective view a surface permanent magnet rotor assembly 10 of the present invention having a conventional rotor core 12, such as one comprising stamped laminations, attached to a shaft 14, and a plurality of alternating polarity permanent magnets 16 affixed to the rotor core 12. A plurality of annular composite powder metal sleeves 18 of the present invention circumferentially surround the permanent magnets 16, the sleeves 18 each comprising magnetically conducting segments 20 in alternating relation with magnetically non-conducting segments 22. The sleeves 18 are aligned with the permanent magnets 16 such that the magnetically conducting segments 20 are generally aligned with the permanent magnets 16 and the magnetically non-conducting segments 22 are generally in between the permanent magnets 16. The non-conducting segments 22 provide insulation that minimizes the magnetic flux leakage between one permanent magnet 16 to the next alternating polarity permanent magnet 16. The magnetically non-conducting segments 22 also provide, in conjunction with the magnetically conducting segments 20, high strength and allow higher speed operation.

FIG. 2 depicts in plan view a rotor-stator assembly 30 including rotor assembly 10 of FIG. 1. Assembly 30 includes a stator core 32 positioned outside the rotor sleeves 18 of rotor assembly 10 with an air gap 34 therebetween to provide a rotor assembly 30 having parallel pole tips.

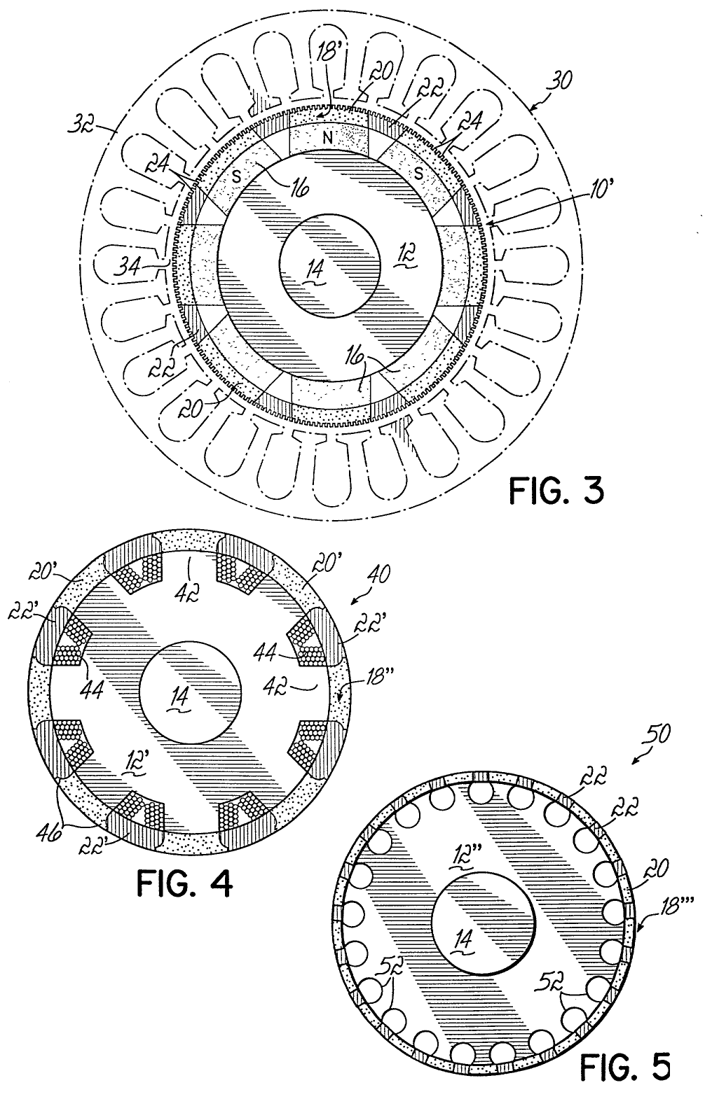

FIG. 3 depicts a rotor assembly 10′ similar in configuration to that depicted in FIGS. 1 and 2, but which includes grooves 24 around the exterior of rotor sleeve 18′ on both the magnetically conducting segments 20 and magnetically non-conducting segments 22. Grooves 24 may be slit into the exterior sleeve surface so as to face the air gap 34 to reduce eddy currents formed by air gap fluctuations, if necessary.

FIG. 4 depicts in plan view a salient pole rotor assembly 40 of the present invention having a rotor core 12′ with a plurality of protrusions 42 extending radially outward, which core 12′ with protrusions 42 may be fabricated from stamped laminations. The rotor core 12′ is attached to a shaft 14 and electrical windings 44 are formed around projections 42. Annular composite powder metal sleeves 18′ of the present invention circumferentially surround the protrusions 42 of core 12′, each sleeve 18″ comprising magnetically conducting segments 20′ in alternating relation with magnetically non-conducting segments 22′. Segments 20′ and 22′ are shaped to form tooth tips 46. The sleeves 18″ are aligned with the rotor core 12′ such that the magnetically conducting segments 20′ are generally aligned with the protrusions 42 and the magnetically non-conducting segments 22′ are generally in between the protrusions 42 adjacent the windings 44.

FIG. 5 depicts in plan view an induction rotor assembly 50 of the present invention having a rotor core 12″ with a plurality of slots 52 arranged around the exterior perimeter, which core 12″ with slots 52 may be fabricated from stamped laminations. The rotor core 12″ is attached to a shaft 14. Thin annular composite powder metal sleeves 18′″ of the present invention circumferentially surround the core 12″, each sleeve 18′″ comprising magnetically conducting segments 20 in alternating relation with magnetically non-conducting segments 22. The sleeves 18′″ are aligned with the rotor core 12″ such that the magnetically non-conducting segments 22 are generally aligned with the slots 52 and the magnetically conducting segments 20 are generally in between the slots 52.

While FIGS. 1-5 depict various embodiments of rotor assemblies, it should be appreciated that numerous other embodiments exist, including those having a varying number of pole tips, and having various sizes of components. The particular embodiments were provided for purposes of explaining representative applications for the composite powder metal rotor sleeve of the present invention. Thus, the invention should not be limited to the particular embodiments shown in FIGS. 1-5.

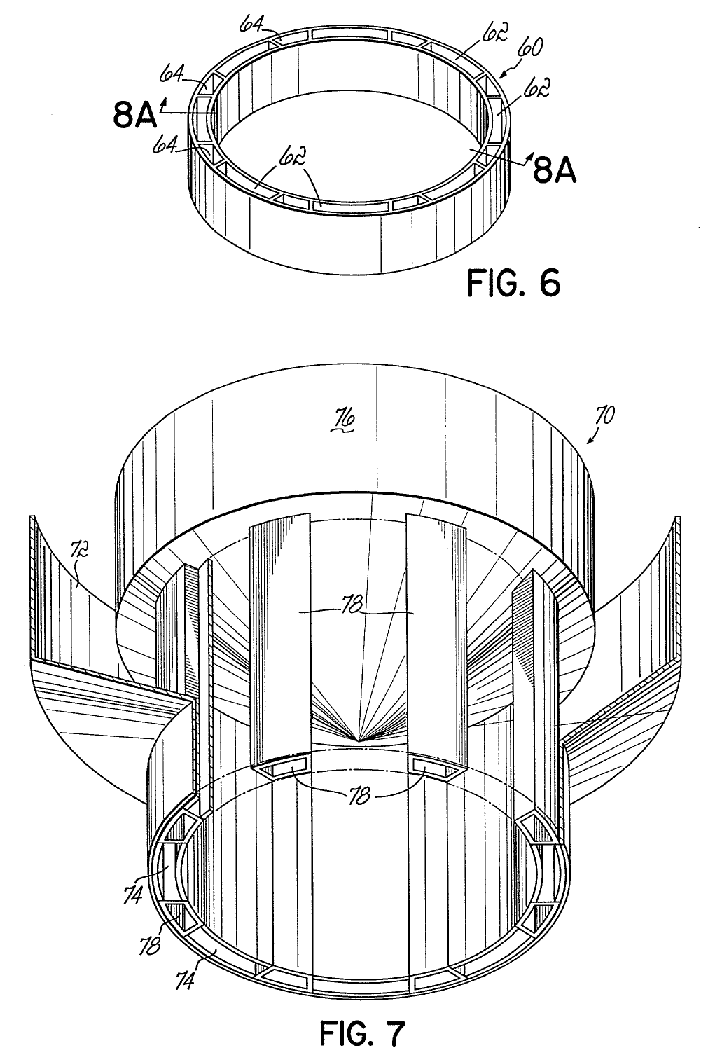

The present invention further provides methods for fabricating composite powder metal sleeves 18 for assembling with a rotor core 12 to form an electric machine. To this end, one method comprises a compaction-sintering operation. A ring-shaped die 60 is provided having discrete regions in a pattern corresponding to the desired rotor sleeve magnetic configuration, as best shown in FIG. 6, which will be discussed in more detail below. Alternating regions of the die 60 are filled with a ferromagnetic powder metal to ultimately form the magnetically conducting segments 20 of the rotor sleeve 18. The other alternating discrete regions of the die 60 are filled with non-ferromagnetic powder metal to ultimately form the magnetically non-conducting segments 22 of the rotor sleeve 18 (See FIG. 1). The powder metals are pressed in the die to form a compacted powder metal ring, also referred to as a green-strength compact. This compacted powder metal is then sintered to form a powder metal sleeve 18 having alternating regions of magnetically conducting material 20 and magnetically non-conducting material 22, the sleeve 18 exhibiting high structural stability. The pressing and sintering process results in magnetically conducting segments 20 having a density of at least 95% of theoretical density, and magnetically non-conducting segments 22 having a density of at least about 85% of theoretical density. One or a plurality of sleeves 18 are then slipped over a rotor core 12 to form a rotor assembly 10. The method for forming these rotor assemblies provides increased mechanical integrity, reduced flux leakage, more efficient flux channeling, reduced cost and simpler construction.

In one embodiment of the compaction-sintering method of the present invention, the regions in the die are filled concurrently with the two powder metals, which are then concurrently pressed and sintered. In another embodiment of the method of the present invention, the regions are filled sequentially with the powder metal being pressed and then sintered after each filling step. In other words, one powder metal is filled into alternating regions of the die, pressed and sintered, and then the second powder metal is filled into the other alternating regions and the entire assembly is pressed and sintered.

The pressing of the filled powder metal may be accomplished by uniaxially pressing the powder in a die, for example at a pressure of about 45-50 tsi. It should be understood that the pressure needed is dependent upon the particular powder metal materials that are chosen. In a further embodiment of the present invention, the pressing of the powder metal involves heating the die to a temperature in the range of about 275° F. (135° C.) to about 290° F. (143° C.), and heating the powders within the die to a temperature in the range of about 175° F. (79° C.) to about 225° F. (107° C.).

The sintering of the pressed powder comprises heating the compacted powder metal to a first temperature of about 1400° F. (760° C.) and holding at that temperature for about one hour. Generally, the powder metal includes a lubricating material, such as a plastic, on the particles to increase the strength of the material during compaction. The internal lubricant reduces particle-to-particle friction, thus allowing the compacted powder to achieve a higher strength after sintering. The lubricant is then burned out of the composite during this initial sintering operation, also known as a delubrication or delubing step. A delubing for one hour is a generally standard practice in the industry and it should be appreciated that times above or below one hour are sufficient for the purposes of the present invention if delubrication is achieved thereby. Likewise, the temperature may be varied from the general industry standard if the ultimate delubing function is performed thereby. After delubing, the sintering temperature is raised to a full sintering temperature, which is generally in the industry about 2050° F. (1121° C.). During this full sintering, the compacted powder shrinks, and particle-to-particle bonds are formed, generally between iron particles. Standard industry practice involves full sintering for a period of one hour, but it should be understood that the sintering time and temperature may be adjusted as necessary. The sintering operation may be performed in a vacuum furnace, and the furnace may be filled with a controlled atmosphere, such as argon, nitrogen, hydrogen or combinations thereof. Alternatively, the sintering process may be performed in a continuous belt furnace, which is also generally provided with a controlled atmosphere, for example a hydrogen/nitrogen atmosphere such as 75% H₂/25% N₂. Other types of furnaces and furnace atmospheres may be used within the scope of the present invention as determined by one skilled in the art.

For the purposes of illustrating the compaction-sintering method of the present invention, FIGS. 6-8E depict die inserts, hopper configurations and pressing techniques that may be used to achieve the concurrent filling or sequential filling of the powder metals and subsequent compaction to form the composite powder metal rotor sleeves of the present invention. It is to be understood, however, that these illustrations are merely examples of possible methods for carrying out the present invention.

FIG. 6 depicts a die insert 60 that may be placed within a die cavity to produce the powder metal sleeve 18 of FIGS. 1 and 2. The two powder metals, i.e. the ferromagnetic and non-ferromagnetic powder metals, are filled concurrently or sequentially into the separate insert cavities 62,64, and then the insert 60 is removed. By way of example only, FIG. 7 depicts a hopper assembly 70 that may be used to fill the insert 60 of FIG. 6 with the powder metals. In this assembly 70, an outer bowl 72 is provided having a plurality of tubes 74 corresponding to cavities 62 of die insert 60 for forming the magnetically conducting segments 20 of the rotor sleeve 18 of FIGS. 1 and 2. This outer bowl 72 is adapted to hold and deliver the ferromagnetic powder metal. An inner bowl 76 is positioned within the outer bowl 72, with a plurality of tubes 78 corresponding to cavities 64 of die insert 60 for forming the magnetically non-conducting segments 22 of the rotor sleeve 18. This inner bowl 76 is adapted to hold and deliver non-ferromagnetic powder metal. This dual hopper assembly 70 enables either concurrent or sequential filling of the die insert 60 of FIG. 6.

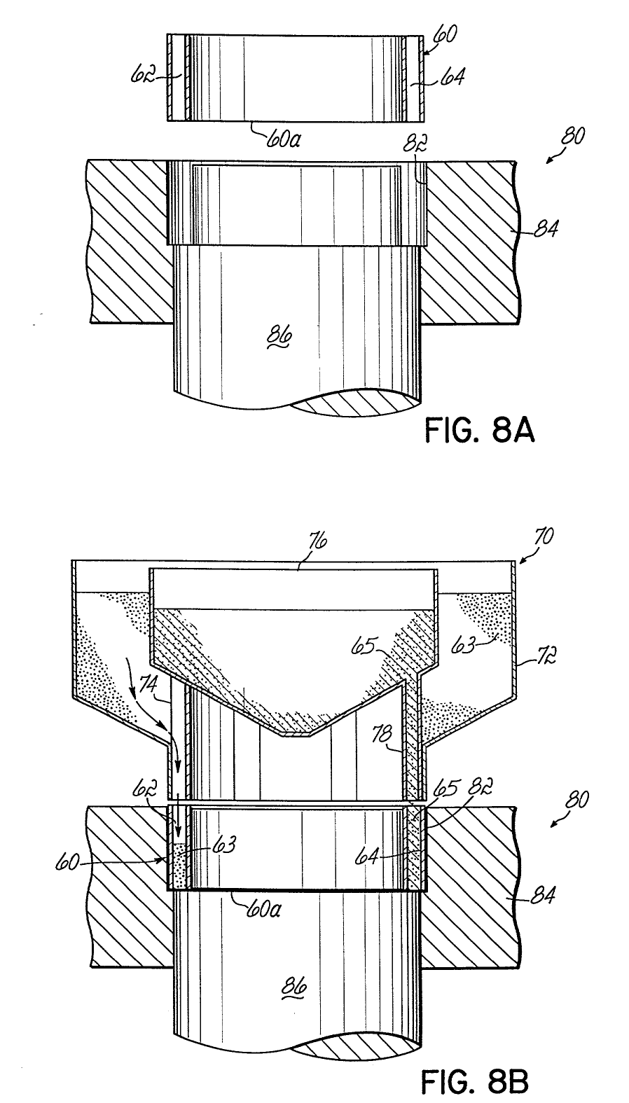

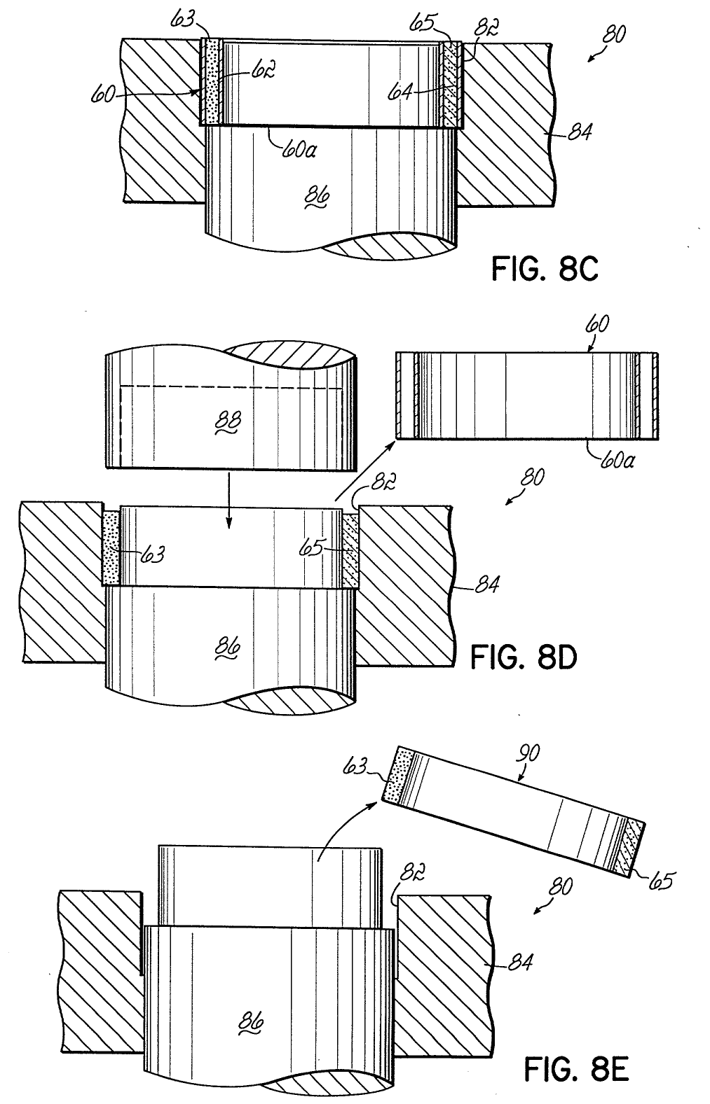

FIGS. 8A-8E depict schematic views in partial cross-section taken along line 8A-8A of FIG. 6 of how the die insert 60 of FIG. 6 and the hopper assembly 70 of FIG. 7 can be used with a uniaxial die press 80 to produce the composite powder metal rotor sleeve 18 of FIGS. 1 and 2. In this method, the die insert 60 is placed within a cavity 82 in the die 84, as shown in FIG. 8A, with a lower punch 86 of the press 80 abutting the bottom 60a of the insert 60. The hopper assembly 70 is placed over the insert 60 and the powder metals 63,65 are filled into the insert cavities 62,64, concurrently or sequentially, as shown in FIG. 8B. The hopper assembly 70 is then removed, leaving a filled insert 60 in the die cavity 82, as shown in FIG. 8C. Then the insert 60 is lifted out of the die cavity 82, which causes some settling of the powder, as seen in FIG. 8D. The upper punch 88 of the press 80 is then lowered down upon the powder-filled die cavity 82, as shown by the arrow in FIG. 8D, to uniaxially press the powders in the die cavity 82. The final composite part 90, or green-strength compact, is then ejected from the die cavity 82 by raising the lower punch 86. The part 90 is next transferred to a sintering furnace (not shown). Where the filling is sequential, the first powder is poured into either the outer bowl 72 or inner bowl 76, and a specially configured upper punch 88 is lowered so as to press the filled powder, and the partially filled and compacted insert (not shown) is sintered. The second fill is then effected and the insert 60 removed for pressing, ejection and sintering of the complete green-strength compact 90. Additional variations on the compaction-sintering process may be found in the above-cited co-pending application Ser. Nos. 09/970,230, 09/970,197, 09/970,223, 09/970,105, and 09/970,106.

Another method of the present invention for forming the rotor sleeve 18 is metal injection molding (MIM). The general process for injection molding includes selecting the two powder materials and the binder system for the particular rotor sleeve to be molded. The powders are each blended or mixed together with binder and granulated or pelletized to provide the feedstocks for the subsequent molding process. The powder material is mixed with the binder system to hold the powder material together prior to injection molding. The binder or carrier may be, for example, a plastic, wax, water or any other suitable binder system used for metal injection molding. By way of further example, the binder system may include a thermoplastic resin, including acrylic polyethylene, polypropylene, polystyrene, polyvinyl chloride, polyethylene carbonate, polyethylene glycol, and polybutyl methacrylate. Non-restrictive examples of waxes include bees, Japan, montan, synthetic, microcrystalline and paraffin waxes. The binder system may also contain, if necessary, plasticizers, such as dioctyl phthalate, diethyl phthalate, di-n-butyl phthalate and diheptyl phthalate. Generally, a feedstock for metal injection molding will contain a binder system in an amount up to about 70% by volume, with about 30-50% being most common.

For the molding process, each feedstock is heated to a temperature sufficient to allow the mixture's injection through an injection unit. Although some materials may be injected at temperatures as low as room temperature, the mixtures are typically heated to a temperature between about 85° F. (29° C.) to about 385° F. (196° C.). The melted feedstocks are then injected into a mold, either sequentially or concurrently, under moderate pressure (i.e., less than about 10,000 psi) and allowed to solidify to form a green-strength compact. The green-strength compact is then ejected from the mold. The melting and injection are typically conducted in an inert gas atmosphere, such as argon, nitrogen, hydrogen and helium. The rates of injection are not critical to the invention, and can be determined by one skilled in the art in accordance with the compositions of each feedstock. Different injection units may be used for each feedstock to avoid cross-contamination where such contamination should be avoided.

Following ejection of the parts from the mold, the molded parts are debinded to remove the binder material. Debinding processes are well known to those skilled in the art of powder metallurgy, and are described in detail in the above-cited co-pending application Ser. No. 09/970,226. By way of example, one general practice in the industry for thermal debinding of an MIM part includes heating to a temperature in the range of about 212° F. (100° C.) to about 1562° F. (850° C.), typically about 1400° F. (760° C.), and holding at that temperature for less than about 6 hours, typically about 1-2 hours, to bum off the binder material.

The composite part is then subjected to a sintering process, which is also well known to those skilled in art of powder metallurgy. The sintering step typically comprises raising the temperature from the debinding step to a higher temperature in the range of about 1742° F. (950° C.) to about 3272° F. (1800° C.), typically about 2050° F. (1121 ° C.), and holding at that temperature for less than about 6 hours, typically about 1-2 hours. Sintering achieves densification chiefly by formation of particle-to-particle binding, thereby forming a high-density, coherent mass of two or more materials with clear, well-defined boundaries therebetween. Densities approaching full theoretical density are possible in the composite MIM parts of the present invention, generally up to about 99% of theoretical.

It should be understood that dissimilar materials behave differently during injection and solidification, such that the dissimilar materials should be selected or manipulated to have similar shrinkage ratios, as well as compatible binder removal and sintering cycles to minimize defects in the final product, where such defects would render the part unacceptable for its purpose. By way of example only, particle size, particle size distribution, particle shape and purity of the powder material can be selected or manipulated to affect such properties or parameters as apparent density, green strength, compressibility, sintering time and sintering temperature. The amount and type of binder mixed with each powder material may also affect various properties of the feedstock, green compact and sintered component, and various process parameters. The method for forming the powder materials, including mechanical, chemical, electrochemical and atomizing processes, also can affect the performance of the powder material during the injection molding process.

The mold is designed according to the pattern desired for the composite rotor sleeve. Molds for metal injection molding are advantageously comprised of a hard material, such as steel, so as to withstand abrasion from the powder materials. Sliding cores, ejectors, and other moving components can be incorporated in the mold when necessary to form the different material regions of the composite sleeve. Thus, the mold is created to have a plurality of cavities into which the feedstocks are injected. The cavities correspond to the particular design needed for the desired machine type. The overall mold is generally annular, which corresponds to the general shape of a rotor sleeve for mounting over a rotor core and shaft to form a rotor assembly of an electric machine. Rotor sleeves that require geometries and material boundaries that are intricate, such as the tooth tips 46 for the salient pole rotor sleeve 18″ of FIG. 4, are advantageously fabricated by MIM such that the tight tolerances achievable in injection molding can enable manufacture of a superior, high density intricate rotor sleeve.

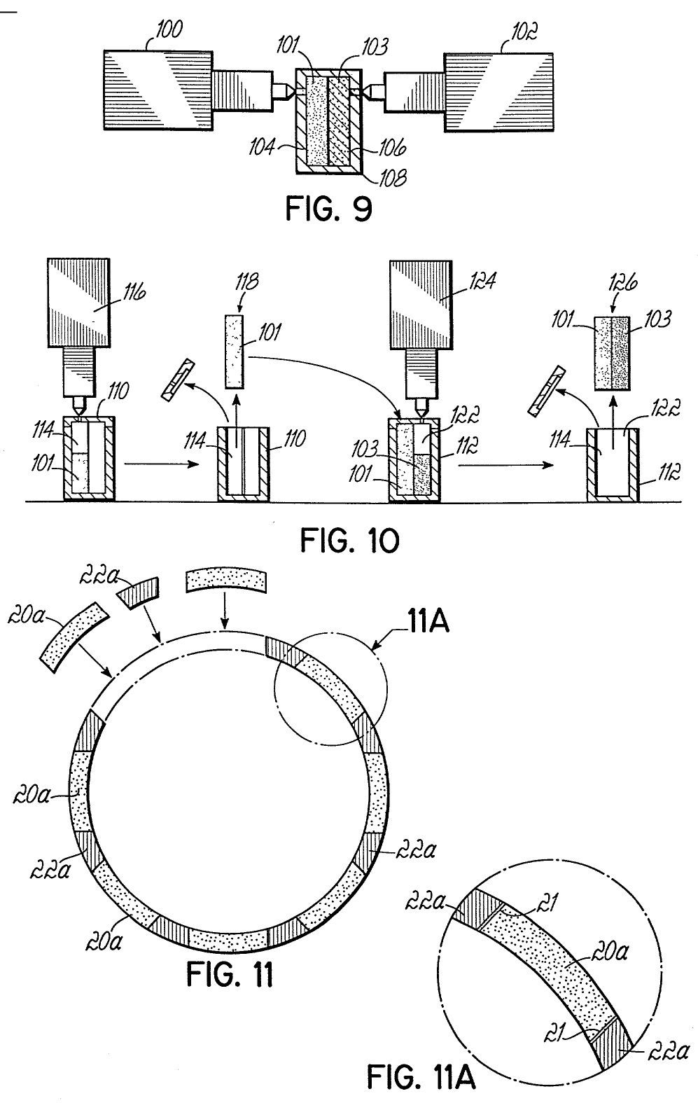

Referring further to the Figures to illustrate the MIM method of the present invention, FIG. 9 depicts one embodiment of the present invention utilizing a single molding machine (not shown) having two injection units 100,102 for filling respective alternating cavities 104,106 of a single mold 108 with two dissimilar materials 101,103, specifically ferromagnetic and non-ferromagnetic powder metals. As stated above, the mold is generally annularly shaped, which corresponds to the general shape of a rotor sleeve. The injection units 100,102 may be stationary during the injection process with the mold rotated to fill the cavities 104,106, or the injection units 100,102 may be rotated or moved to inject the two materials 101,103 concurrently or sequentially to form the composite green-strength part. Once all of the materials have been injected and have been allowed to solidify, the mold 108 is opened and the part ejected therefrom. The part may then be subjected to known binder removal and sintering processes to form a final high-density composite part.

FIG. 10 depicts an alternative embodiment of the MIM method of the present invention. In this embodiment, multiple molds 110,112 are used to inject each of the two materials 101,103 independently or sequentially. A first material or melted feedstock 101 is injected into alternating cavities 114 in the first mold 110 by an injection unit 116 to form the proper shape. For purposes of simplicity of depiction, each mold 110,112 shown in FIG. 10 has two cavities 114,122, each cavity receiving a different material, for forming a two-material composite part. It is to be understood, however, that the first feedstock 101 may be injected into a plurality of cavities 114, and the second feedstock 103 may be injected into a plurality of cavities 122 to form a composite rotor sleeve of alternating materials. After the first material 101 is injected, and allowed to solidify, the partially formed part 118 is then ejected and placed into a second mold 112. A second dissimilar material 103 is injected into another cavity 122 in mold 112, either by a second injection unit 124 from the same single machine (not shown), or by an injection unit 124 of a second machine (not shown). After the second material 103 is allowed to solidify, the complete molded part 126, or green-strength compact, is ejected from the second mold 112, and the compact 126 is debinded and sintered. Additional variations in the MIM process may be found in the above-cited co-pending application Ser. No. 09/970,226.

Another method of the present invention for forming the rotor sleeve 18 is sinterbonding, which is described in further detail in the context of rotor core formation in co-pending U.S. patent application Ser. No. ______ filed on even date herewith and entitled “Sinterbonded Electric Machine Components” which is incorporated by reference herein it is entirety. The ferromagnetic and non-ferromagnetic powder metals are pressed separately in individual dies to form compacted powder metal segments 20a, 22a, or green-strength segments, as shown in FIG. 11. The compacted powder metal segments 20a, 22a are then positioned adjacent to each other in the desired magnetic pattern as indicated by the arrows. A small amount of powder metal 21 is then provided between the green-strength segments 20a, 22a, as depicted in FIG. 11A, which is an enlarged view of a portion of FIG. 11, and the arrangement is then sintered to form a sinterbonded powder metal rotor sleeve 18 having alternating regions of magnetically non-conducting material 22 and magnetically conducting material 20, as shown in FIGS. 1 and 2, the component exhibiting high structural stability and definitive boundaries between regions.

The small amount of powder material 21, such as high purity iron powder, facilitates bond formation between the separate green-strength segments 20a, 22a during sintering. The amount of powder metal 21 provided between green-strength segments 20a, 22a may be any amount deemed necessary or adequate for a bond to form between the segments. In an embodiment of the present invention, the small amount of powder metal 21 added between the green-strength segments 20a, 22a is a ferromagnetic material, such as described above. For example, the small amount of added powder metal 21 may be high purity iron powder, such as covered by MPIF Standard 35 F-0000. In another embodiment of the present invention, the small amount of added powder metal 21 is the same powder metal as used to form the magnetically conducting segments 20 of the rotor sleeve 18. Alternatively, the small amount of added powder metal 21 may be a non-ferromagnetic material, such as described above. For example, the small amount of added powder metal 21 may be an austenitic stainless steel, such as SS316. In yet another embodiment of the present invention, the small amount of added powder metal 21 is the same powder metal as used to form the magnetically non-conducting segments 22 of the rotor sleeve 18.

The pressing or compaction of the filled powder metal to form the green-strength segments 20a, 22a and the subsequent debinding and full sintering may be accomplished as described above for the compaction-sintering method or by the MIM method. Additional variations in the sinterbonding process may be found in co-pending application Ser. No. ______ filed on even date herewith and entitled “Sinterbonded Electric Machine Components.”

Composite powder metal rotor sleeves, whether they are compacted or injection-molded as described in the co-pending applications referred to above or whether they are sinterbonded, may be used in conjunction with traditional stamped electric machine cores to provide a strength and performance advantage over sleeveless cores. Composite powder metal sleeves add strength to the traditional stamped electric machine cores because they may utilize relatively large amounts of non-permeable material, for example stainless steel, to add structural stability while minimizing or eliminating the magnetic flux leakage pathways. With less or no flux leakage, they also perform better in terms of output power, power factor and efficiency. Thus, the addition of composite powder metal sleeves of the present invention produces electric machine components that are stronger, faster and more efficient than those comprising only the stamped laminations.

While the present invention has been illustrated by the description of embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of applicant's general inventive concept.

What is claimed is:

1. An annular composite powder metal rotor sleeve for placing over an annular rotor core, the sleeve comprising a plurality of magnetically conducting segments of sintered ferromagnetic powder metal in alternating relation with a plurality of magnetically non-conducting segments of sintered non-ferromagnetic powder metal to form the annular composite powder metal rotor sleeve.

2. The sleeve of claim 1 wherein the ferromagnetic powder metal is Ni, Fe, Co or an alloy thereof.

3. The sleeve of claim 1 wherein the ferromagnetic powder metal is a high purity iron powder with a minor addition of phosphorus.

4. The sleeve of claim 1 wherein the non-ferromagnetic powder metal is an austenitic stainless steel.

5. The sleeve of claim 1 wherein the non-ferromagnetic powder metal is an AISI 8000 series steel.

6. A powder metal rotor assembly for an electric machine, comprising:
a shaft;
a rotor core comprising a plurality of laminations affixed to the shaft;
at least one composite powder metal sleeve circumferentially surrounding the laminations, the at least one sleeve comprising a plurality of magnetically conducting segments of sintered ferromagnetic powder metal in alternating relation with a plurality of magnetically non-conducting segments of sintered non-ferromagnetic powder metal.

7. The assembly of claim 6 wherein the ferromagnetic powder metal is Ni, Fe, Co or an alloy thereof.

8. The assembly of claim 6 wherein the ferromagnetic powder metal is a high purity iron powder with a minor addition of phosphorus.

9. The assembly of claim 6 wherein the non-ferromagnetic powder metal is an austenitic stainless steel.

10. The assembly of claim 6 wherein the non-ferromagnetic powder metal is an AISI 8000 series steel.

11. A method of making an annular composite powder metal rotor sleeve for placing over an annular rotor core, the sleeve comprising a plurality of magnetically conducting segments in alternating relation with a plurality of magnetically non-conducting segments, the method comprising:
placing a plurality of green-strength magnetically conducting segments adjacent a plurality of green-strength magnetically non-conducting segments in alternating relation to form a ring;
adding powder metal between the segments; and
sintering the segments and added powder metal whereby the segments are bonded together by the added powder metal to form the annular composite powder metal rotor sleeve.

12. The method of claim 11 further comprising forming the plurality of green-strength magnetically conducting segments by pressing a ferromagnetic powder metal and forming the plurality of green-strength magnetically non-conducting segments by pressing a non-ferromagnetic powder metal.

13. The method of claim 12 wherein the added powder metal is the ferromagnetic powder metal.

14. The method of claim 12 wherein the added powder metal is the non-ferromagnetic powder metal.

15. The method of claim 12 wherein the ferromagnetic powder metal is Ni, Fe, Co or an alloy thereof.

16. The method of claim 12 wherein the ferromagnetic powder metal is a high purity iron powder with a minor addition of phosphorus.

17. The method of claim 12 wherein the non-ferromagnetic powder metal is an austenitic stainless steel.

18. The method of claim 12 wherein the non-ferromagnetic powder metal is an AISI 8000 series steel.

19. The method of claim 12 wherein pressing comprises uniaxially pressing the powder in a die.

20. The method of claim 19 wherein pressing comprises pre-heating the powder and pre-heating the die.

21. The method of claim 11 wherein the added powder metal comprises a magnetically conducting material.

22. The method of claim 11 wherein the added powder metal comprises a magnetically non-conducting material.

23. The method of claim 11 wherein sintering includes delubricating the segments by heating to a first temperature, followed by fully sintering the segments by heating to a second temperature greater than the first temperature.

24. The method of claim 11 further comprising slipping a plurality of the composite powder metal sleeves circumferentially over a rotor core comprising laminations to form a rotor assembly for an electric machine.

25. A method of making an annular composite powder metal rotor sleeve for placing over an annular rotor core, the sleeve comprising a plurality of magnetically conducting segments in alternating relation with a plurality of magnetically non-conducting segments, the method comprising:
filling a plurality of first regions in a ring-shaped die with a ferromagnetic powder metal;
filling a plurality of second regions in the die with a non-ferromagnetic powder metal, the second regions in alternating relation with the first regions;
pressing the powders in the die to form a compacted powder metal ring; and
sintering the compacted powder metal ring to form the annular composite powder metal rotor sleeve.

26. The method of claim 25 wherein the first and second regions are filled concurrently.

27. The method of claim 25 wherein the first and second regions are filled sequentially with the powder metal being pressed and sintered after each filling step.

28. The method of claim 25 wherein the ferromagnetic powder metal is Ni, Fe, Co or an alloy thereof.

29. The method of claim 25 wherein the ferromagnetic powder metal is a high purity iron powder with a minor addition of phosphorus.

30. The method of claim 25, wherein the non-ferromagnetic powder metal is an austenitic stainless steel.

31. The method of claim 25, wherein the non-ferromagnetic powder metal is an AISI 8000 series steel.

32. The method of claim 25, wherein the pressing comprises uniaxially pressing the powders in the die.

33. The method of claim 32, wherein the pressing comprises pre-heating the powders and pre-heating the die.

34. The method of claim 25, wherein, after the pressing, the compacted powder metal ring is de-lubricated at a first temperature, followed by sintering at a second temperature greater than the first temperature.

35. The method of claim 25 further comprising slipping a plurality of the composite powder metal sleeves circumferentially over a rotor core comprising laminations to form a rotor assembly for an electric machine.

36. A method of making an annular composite powder metal rotor sleeve for placing over an annular rotor core, the sleeve comprising a plurality of magnetically conducting segments in alternating relation with a plurality of magnetically non-conducting segments, the method comprising:
injecting a ferromagnetic powder material from a first injection unit under heat and pressure into a plurality of first mold cavities in a ring-shaped mold, and allowing the ferromagnetic material to solidify;
injecting a non-ferromagnetic powder material from a second injection unit under heat and pressure into a plurality of second mold cavities in the mold, the second mold cavities in alternating relation with the first mold cavities, and allowing the non-ferromagnetic material to solidify to thereby produce a composite injection molded green-strength ring; and
sintering the composite ring.

37. The method of claim 36 further comprising, prior to sintering, ejecting the green-strength ring from the mold and subjecting the green-strength ring to debinding to provide a composite ring that is essentially free of binder.

38. The method of claim 36 wherein the ferromagnetic and non-ferromagnetic powder materials are injected concurrently.

39. The method of claim 36 wherein the ferromagnetic and non-ferromagnetic powder materials are injected sequentially.

40. The method of claim 36, wherein the ferromagnetic powder material is a soft ferromagnetic powder metal selected from the group consisting of Ni, Fe, Co and alloys thereof.

41. The method of claim 36, wherein the ferromagnetic powder material is a soft ferromagnetic high purity iron powder with a minor addition of phosphorus.

42. The method of claim 36, wherein the non-ferromagnetic powder material is an austenitic stainless steel.

43. The method of claim 36, wherein the non-ferromagnetic powder material is an AISI 8000 series steel.

44. The method of claim 36, wherein the ferromagnetic and non-ferromagnetic powder materials are each combined with a binder prior to injecting.

45. The method of claim 36 further comprising slipping a plurality of the composite powder metal sleeves circumferentially over a rotor core comprising laminations to form a rotor assembly for an electric machine.
